(19) United States
(12) Patent Application Publication
(10) Pub. No.: US 2026/0318220 A1
(43) Pub. Date: Oct. 15, 2026

(54) Variable Vanes and Lever Arms

(71) Applicant: RTX Corporation, Farmington, CT (US)

(72) Inventors: Samuel B. Hoyt, Farmington, CT (US); Fadi Samir Maalouf, East Hampton, CT (US)

(73) Assignee: RTX Corporation, Farmington, CT (US)

(21) Appl. No.: 19/177,485

(22) Filed: Apr. 11, 2025

(51) Int. Cl. F01D 17/16

(52) U.S. Cl. CPC F01D 17/16

(57) ABSTRACT

A vane assembly has a vane and an arm having first and second holes in its shank proximate first and second ends. First and second tabs project laterally opposite each other from the shank proximate the second end and have: a bend; and a distal portion distally of the bend overlapping and spaced apart from and having a face facing the shank second face. The second tab distal portion partially overlaps the first tab distal portion. A third hole in the second tab distal portion overlaps a distal end edge of the first tab and has proximal and distal edges. A vane shaft has a first facet abutting the proximal edge of the third hole, a second facet abutting the first tab, and a third facet circumferentially between the first facet and the second facet and abutting at least one of the first tab and the second tab.

### BACKGROUND

The disclosure relates to variable lever arms. More particularly, the disclosure relates to vane lever arms such as used for variable vanes of a gas turbine engine.

Gas turbine engines (used in propulsion and power applications and broadly inclusive of turbojets, turboprops, turbofans, turboshafts, industrial gas turbines, and the like) may include variable vane stages in one or more sections of the engine. In a variable vane stage, a circumferential array of vane airfoils are each rotatable about the respective associated axis of rotation. The vane airfoils may each be mounted for such a rotation to an inner diameter (ID) platform/shroud or inner casing and an outer diameter (OD) shroud or outer casing. Vane rotation may be driven by respective lever arms typically mounted to an outer diameter (OD) shaft of the vane.

Example vane lever arms extend between a driving end and a driven end. The driving end includes one or more features for mounting to a driver such as a synchronizing ring. The driven end includes one or more features for mounting to the associated vane OD shaft/stem to rotate said vane about its axis of rotation.

A number of constructions of vane arms exist. U.S. Pat. No. 10,161,260B2 (the '260 patent) of Morganti et al., Dec. 25, 2018, entitled “Vane Lever Arm for a Variable Area Vane Arrangement”, discloses vane arms formed via bending sheet metal stock. The disclosure of the '260 patent is incorporated by reference in its entirety herein as if set forth at length. The vane may be formed by bending a cut generally T-shaped piece of the sheet stock. The driving end is formed at the end of the leg of the T and has a hole/aperture for accommodating a drive pin engaged by the synchronizing ring. The driven end is formed near the head or intersection of the leg and the arms of the T. Near the head/intersection, the leg has a hole/aperture for receiving a threaded shaft/stem of the vane.

The arms are bent around to overlap. The overlapping one of the arms has an aperture through which the vane shaft/stem passes in the mounted condition. The overlapped arm end protrudes over the overlapping arm aperture. A proximal portion of the vane shaft/stem is clamped by abutting contact of both a proximal edge of the overlapping arm aperture and the overlapped arm distal end.

To install the vane arm of the '260 patent to its associated vane, a tool is used to spread the arms slightly apart to reduce the overlap of the overlapped arm distal end and the overlapping arm aperture. The spreading provides clearance to install with the overlapping arm aperture passing over the threaded distal end portion of the shaft and over a region proximal of the threads having opposite parallel flats. Ultimately, the shaft passes through the head end aperture of the leg allowing a tab washer and nut to be installed and tightened down.

Releasing of the tool allows partial relaxation of the arms to compressively engage the shaft/stem proximal portion flats for registry. The head end hole in the '260 patent is partially circular with a circular arc and a chord providing a flat perimeter surface. In complementary fashion, the shaft threaded end portion has a flat interrupting the threads. The cooperation of the hole flat and shaft flat provides rotational keying to predetermine a single installation orientation of the vane arm relative to the vane.

### SUMMARY

One aspect of the disclosure involves a vane assembly comprising a vane having an airfoil and a shaft protruding from an end of the airfoil and a vane arm. The vane arm comprises: a first end and a second end; a shank extending between the first end and the second end and having a first face and a second face; a first hole in the shank proximate the first end; and a second hole in the shank proximate the second end. A first tab projects laterally from the shank proximate the second end and has: a bend; and a distal portion distally of the bend overlapping and spaced apart from and having a face facing the shank second face. A second tab projects laterally from the shank proximate the second end laterally opposite the first tab and has: a bend; a distal portion distally of the bend overlapping and spaced apart from and facing the shank second face and partially overlapping the first tab distal portion; and a third hole in the second tab and having a proximal edge and a distal edge. The shaft has a first facet abutting the proximal edge of the third hole, a second facet abutting the first tab, and a third facet circumferentially between the first facet and the second facet and abutting at least one of the first tab and the second tab.

In a further embodiment of any of the foregoing embodiments, additionally or alternatively, the first tab distal portion is between the second tab distal portion and the shank.

In a further embodiment of any of the foregoing embodiments, additionally or alternatively, the vane shaft has a shoulder; and a nut holds the vane arm to the shaft compressed between the nut and the shoulder.

In a further embodiment of any of the foregoing embodiments, additionally or alternatively, a tab washer is between the nut and the vane arm and has a tab received in an open channel in the second end.

In a further embodiment of any of the foregoing embodiments, additionally or alternatively, the third facet abuts at least one of the first tab and the second tab.

In a further embodiment of any of the foregoing embodiments, additionally or alternatively, third facet abuts at a surface of the third hole.

In a further embodiment of any of the foregoing embodiments, additionally or alternatively, the first and second facets have upper ends axially offset from each other.

In a further embodiment of any of the foregoing embodiments, additionally or alternatively, the shaft has fourth facet and a fifth facet respectively above the and recessed from the first facet and the second facet.

In a further embodiment of any of the foregoing embodiments, additionally or alternatively, the third facet at least partially axially overlaps the first facet, the second facet, the fourth facet and the fifth facet.

In a further embodiment of any of the foregoing embodiments, additionally or alternatively, the third facet abuts a projection of the first tab.

In a further embodiment of any of the foregoing embodiments, additionally or alternatively, the first tab forks in two with the projection being a tine of the fork.

A further embodiment of any of the foregoing embodiments may additionally and/or alternatively include a pin mounted in and protruding from the first hole.

A further aspect of the disclosure involves a vane stage comprising a plurality of such vane assemblies of and further comprising: a synchronizing ring coupled to the vane arms and having an axis; and for each vane assembly one or more bearings mounting the vane for rotation about an axis of the vane wherein, rotation of the synchronizing ring about its axis rotates the vanes about their respective axes.

Another aspect of the disclosure involves a vane comprising: airfoil and a shaft protruding from an end of the airfoil wherein: the shaft has a first facet, a second facet, and a third facet circumferentially between the first facet and the second facet. The first and second facets have upper ends axially offset from each other. In various implementations the shaft may be assembled to a vane arm as described below via methods and/or in arrangements described above or below.

In a further embodiment of any of the foregoing embodiments, additionally or alternatively, the offset is by 10% to 50% of a spacing between the first facet and the second facet.

Another aspect of the disclosure involves a vane arm comprising: a first end and a second end. A shank extends between the first end and the second end and has a first face and a second face. A first hole is in the shank proximate the first end. A second hole in the shank proximate the second end. A first tab projects laterally from the shank proximate the second end and has: a bend; and a distal portion distally of the bend. A second tab projects laterally from the shank proximate the second end laterally opposite the first tab and has: a bend; a distal portion distally of the bend; and a third hole in the second tab distal portion overlapping a distal end edge of the first tab and having a proximal edge and a distal edge. The first tab forks with a first tine of the fork overlapping the third hole.

In a further embodiment of any of the foregoing embodiments, additionally and/or alternatively, the first tab distal portion is overlapping and spaced apart from and has a face facing the shank second face; and the second tab distal portion is overlapping and spaced apart from and has a face facing the shank second face.

In a further embodiment of any of the foregoing embodiments, additionally and/or alternatively, a second a tine of the fork overlaps the third hole.

In a further embodiment of any of the foregoing embodiments, additionally and/or alternatively, the second tine has a concavity facing the first tine.

In a further embodiment of any of the foregoing embodiments, additionally and/or alternatively, the first tine has a flat facing inward toward a centerline of an arc of the second hole.

In a further embodiment of any of the foregoing embodiments, additionally and/or alternatively, the first, second, and third holes are in a single metallic piece.

In a further embodiment of any of the foregoing embodiments, additionally and/or alternatively, the first, second, and third holes are the only holes in the vane arm.

A further aspect of the disclosure involves a vane assembly including the vane arm and further comprising a vane having an airfoil and a shaft protruding from an end of the airfoil, wherein: the vane shaft extends through the second hole; the vane shaft abuts the third hole proximal edge, the first tine, and an end edge of the first tab proximally of the first tine; the vane shaft has a shoulder; and a nut holds the vane arm to the shaft compressed between the nut and the shoulder.

In a further embodiment of any of the foregoing embodiments, additionally and/or alternatively, a tab washer is between the nut and the vane arm and has a tab received in an open channel in the second end.

In a further embodiment of any of the foregoing embodiments, additionally and/or alternatively, the vane shaft has: a first face abutting the third hole proximal edge; a second face abutting the first tab proximally of the tine; and a third face between the first face and the second face and abutting the first tine.

In a further embodiment of any of the foregoing embodiments, additionally and/or alternatively, the vane has a convexity opposite the third face and a second tine of the fork has a complementary concavity

A further embodiment of any of the foregoing embodiments may additionally and/or alternatively include a pin mounted in and protruding from the first hole.

A further aspect of the disclosure involves a vane stage comprising a plurality of the vane assemblies and further comprising: a synchronizing ring coupled to the vane arms and having an axis; and for each vane assembly one or more bearings mounting the vane for rotation about an axis of the vane wherein, rotation of the synchronizing ring about its axis rotates the vanes about their respective axes.

A further aspect of the disclosure involves a method for using the vane arm, the method comprising: installing the arm to a vane so that a shaft of the vane extending from an end of an airfoil of the vane passes through the third hole and second hole and the vane shaft abuts the third hole proximal edge and a portion of the first tab distal proximally of the first tine; and installing a nut to a threaded portion of the shaft to hold the vane arm to the shaft compressed between the nut and a shoulder of the shaft.

A further embodiment of any of the foregoing embodiments may additionally and/or alternatively include installing a pin to the first hole.

In a further embodiment of any of the foregoing embodiments, additionally and/or alternatively the method is performed with a plurality of vane arms and the respective pins are mounted to a shared synchronizing ring.

Another aspect of the disclosure involves a vane arm comprising: a first end and a second end. A shank extends between the first end and the second end and has a first face and a second face. A first hole is in the shank proximate the first end. A second hole in the shank proximate the second end. A first tab projects laterally from the shank proximate the second end and has: a bend; and a distal portion distally of the bend. A second tab projects laterally from the shank proximate the second end laterally opposite the first tab and has: a bend; a distal portion distally of the bend; and a third hole in the second tab distal portion overlapping a distal end edge of the first tab and having a proximal edge and a distal edge. The third hole has a flat between the third hole distal edge and the third hole proximal edge. The third hole has a concavity between the third hole distal edge and the third hole proximal edge and facing the third hole flat.

In a further embodiment of any of the foregoing embodiments, additionally and/or alternatively, the first tab distal portion is overlapping and spaced apart from and has a face facing the shank second face; and the second tab distal portion is overlapping and spaced apart from and has a face facing the shank second face.

In a further embodiment of any of the foregoing embodiments, additionally and/or alternatively, the first, second, and third holes are in a single metallic piece.

In a further embodiment of any of the foregoing embodiments, additionally and/or alternatively, the first, second, and third holes are the only holes in the vane arm.

A further aspect of the disclosure involves a vane assembly including the vane arm and further comprising a vane having an airfoil and a shaft protruding from an end of the airfoil, wherein: the vane shaft extends through the second hole; the vane shaft abuts the third hole proximal edge, the third hole flat, and a distal end edge of the first tab; the vane shaft has a shoulder; and a nut holds the vane arm to the shaft compressed between the nut and the shoulder.

In a further embodiment of any of the foregoing embodiments, additionally and/or alternatively, a tab washer is between the nut and the vane arm and has a tab received in an open channel in the second end.

In a further embodiment of any of the foregoing embodiments, additionally and/or alternatively, the vane shaft has: a first face abutting the third hole proximal edge; a second face abutting the first tab distal end edge; and a third face between the first face and the second face and abutting the third hole flat.

In a further embodiment of any of the foregoing embodiments, additionally and/or alternatively, the vane has a convexity opposite the third face and complementary to the third hole concavity

A further embodiment of any of the foregoing embodiments may additionally and/or alternatively include a pin mounted in and protruding from the first hole.

A further aspect of the disclosure involves a vane stage comprising a plurality of the vane assemblies and further comprising: a synchronizing ring coupled to the vane arms and having an axis; and for each vane assembly one or more bearings mounting the vane for rotation about an axis of the vane wherein, rotation of the synchronizing ring about its axis rotates the vanes about their respective axes.

A further aspect of the disclosure involves a method for using the vane arm, the method comprising: installing the arm to a vane so that a shaft of the vane extending from an end of an airfoil of the vane passes through the third hole and second hole and the vane shaft abuts the third hole proximal edge and the first tab distal end edge; and installing a nut to a threaded portion of the shaft to hold the vane arm to the shaft compressed between the nut and a shoulder of the shaft.

A further embodiment of any of the foregoing embodiments may additionally and/or alternatively include installing a pin to the first hole.

In a further embodiment of any of the foregoing embodiments, additionally and/or alternatively the method is performed with a plurality of vane arms and the respective pins are mounted to a shared synchronizing ring.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a view of a vane assembly.

FIG. 2 is an enlarged view of a vane actuating arm region of the assembly of FIG. 1.

FIG. 3 is an end view of the vane arm region.

FIG. 4 is a view of the vane arm.

FIG. 5 a view of the vane.

FIG. 6 is a sectional view of the vane arm region taken along line 6-6 of FIG. 2.

FIG. 7 is a sectional view of the vane arm region taken along line 7-7 of FIG. 6.

FIG. 8 is a sectional view of the vane arm region taken along line 8-8 of FIG. 3.

FIG. 9 is an outer diameter (OD) view of a distal end of an outer diameter (OD) shaft section of the vane of the assembly.

FIG. 10 is a first side view of a vane mounting portion of the OD shaft section.

FIG. 11 is a second side view of a vane mounting portion of the OD shaft section.

FIG. 12 is an inner diameter (ID) face view of a vane arm of the assembly.

FIG. 13 is a view of a second vane arm.

FIG. 14 is a sectional view of a vane assembly including the second vane arm and taken along line 14-14 of FIG. 13.

Like reference numbers and designations in the various drawings indicate like elements.

### DETAILED DESCRIPTION

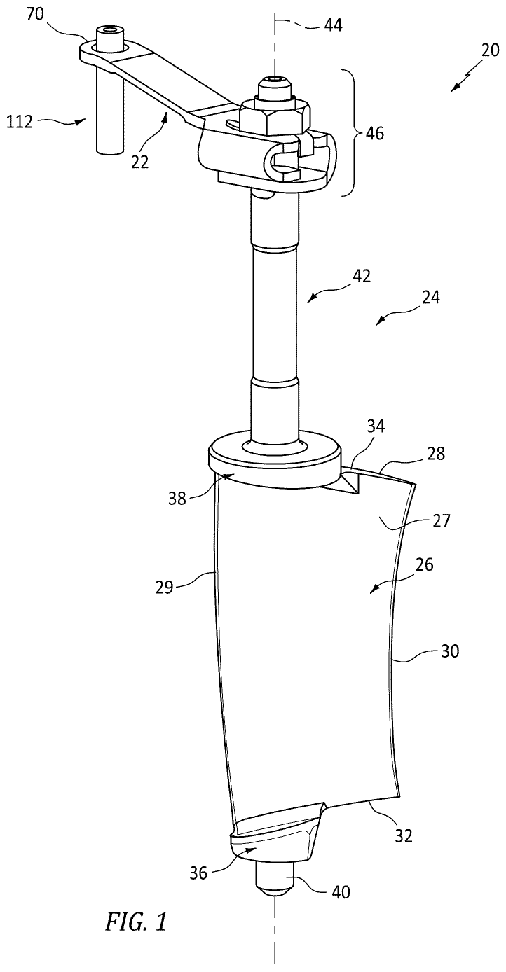

FIG. 1 shows a vane assembly 20 including vane arm 22 and vane 24 configured as a modification of the baseline of the '260 patent. The vane 24 includes an airfoil 26 having a pressure side 27, a suction side 28, a leading edge 29, and a trailing edge 30. The airfoil extends along a span from an inner diameter (ID) end 32 to an outer diameter (OD) end 34. Such ID and OD are measured essentially relative to the engine centerline. The airfoil ID and OD ends respectively merge, along forward/leading portions thereof, with respective ID and OD platforms 36 and 38. Respectively inward and outward from the platforms 36 and 38 are an ID shaft 40 and an OD shaft 42. The shafts are coaxial along a vane axis 44 which forms an axis of rotation and axis of threads of a threaded portion 50 discussed below. The OD shaft 42 includes a distal mounting section 46 for mating with the vane arm 22. Example vane materials are cast and machined metallic alloys such as nickel-based alloys and superalloys.

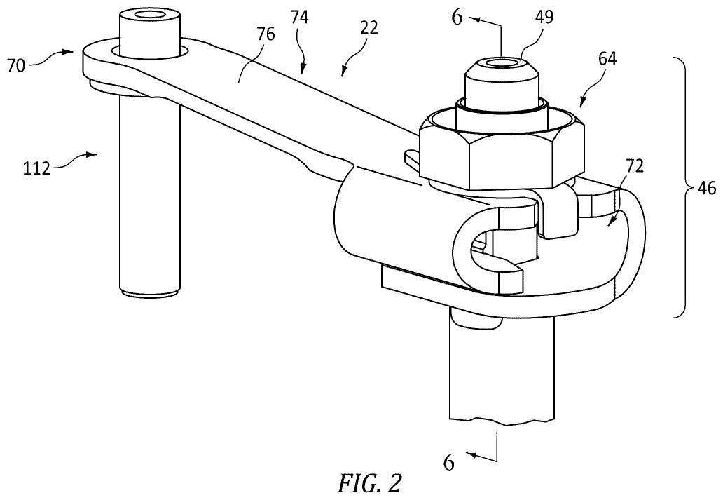

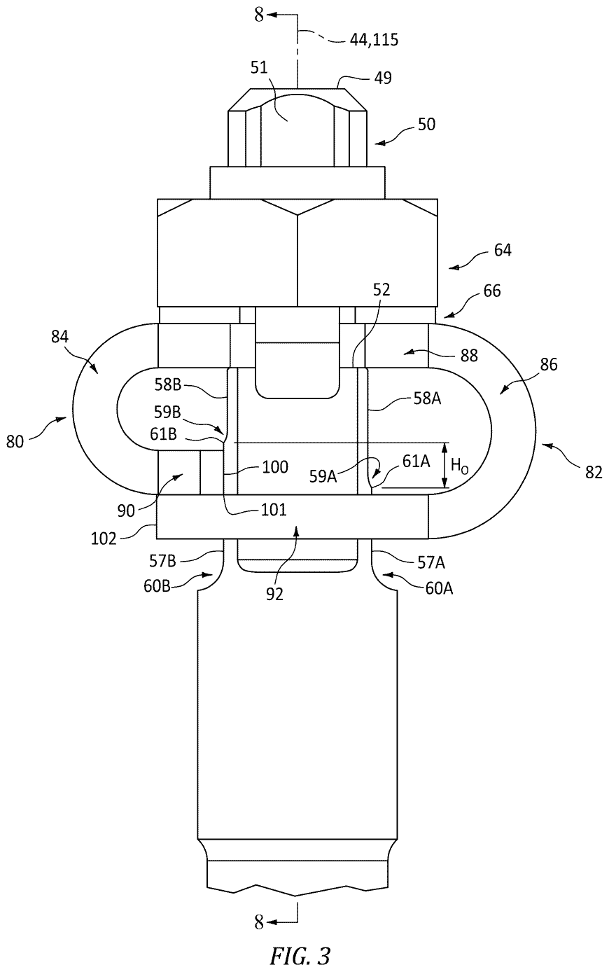

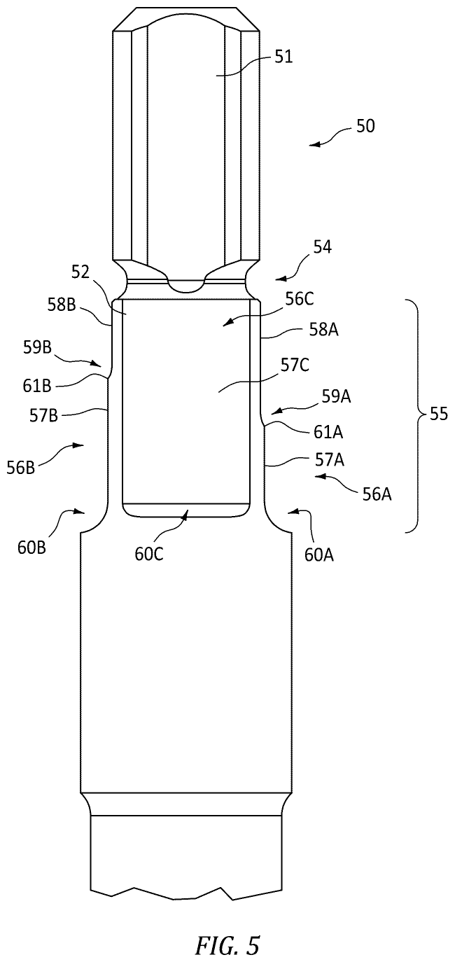

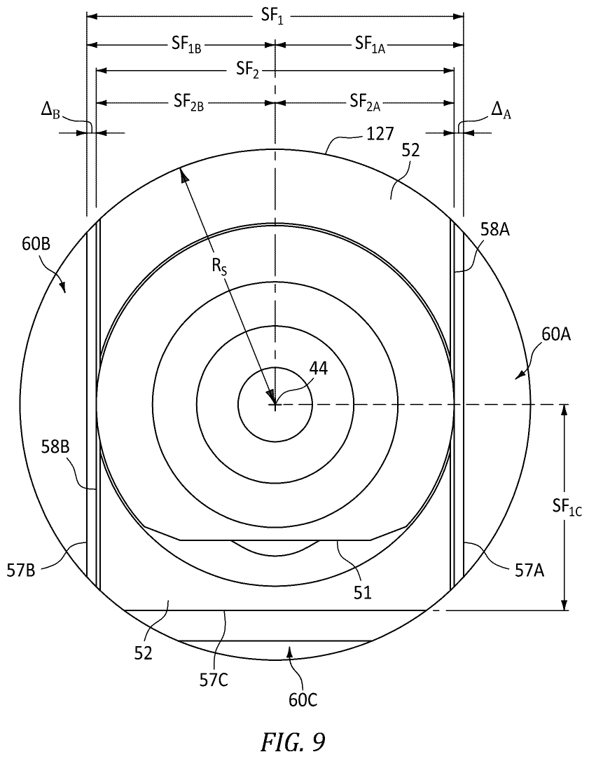

The mounting section 46 includes an externally threaded section/region/portion 50 (FIG. 3) with a shoulder surface 52 radially inward thereof or proximal relative to the airfoil. The shoulder 52 is separated from the threaded section by a necked region 54 (FIG. 5). Below/inward of the shoulder is a faceted section 55 (FIG. 5) having opposed first and second lateral faces 56A and 56B. Each face 56A, 56B has a lower/proximal facet 57A, 57B (FIG. 3) and an upper/distal facet 58A, 58B. For each face, the upper facet extends downward from the shoulder 52 with respective concave transitions 59A, 59B to the associated lower facet. Similarly, the lower facets 57A, 57B extend to respective concave transitions 60A, 60B to intact circular surface of the stem. The respective lower facets have upper edges 61A, 61B. These facets 56A,56B,57A,57B extend, along a substantial majority of their axial lengths parallel to the axis 44. A third face 56C is circumferentially between the faces 56A and 56B. In the illustrated example, this face 56C comprises a single facet 57C essentially axially overlapping both facets of each of the lateral pairs of facets. The facet 57C extends axially proximally (away from the threaded section 50) to a concave transition 60C to intact right circular cylindrical surface of a region proximally thereof. In the example, this intact circular cylindrical surface extends distally to the necked region 54 at opposite sides of the facet 57C in respective small circumferential gaps with the adjacent lateral faces 56A,56B. Additionally, the intact circular cylindrical surface extends diametrically opposite the face 56C/facet 57C in a region labeled 127 in FIGS. 9, 10, and 11. In the illustrated example, the faces 56A and 56B and their respective facets are parallel to each other diametrically opposite the axis 44. FIG. 2 also shows a nut 64 installed to the threaded section 50 and a tab washer 66 between the nut and the arm. The tab washer has an annular body 68 and a tab 69 bent at an angle thereto.

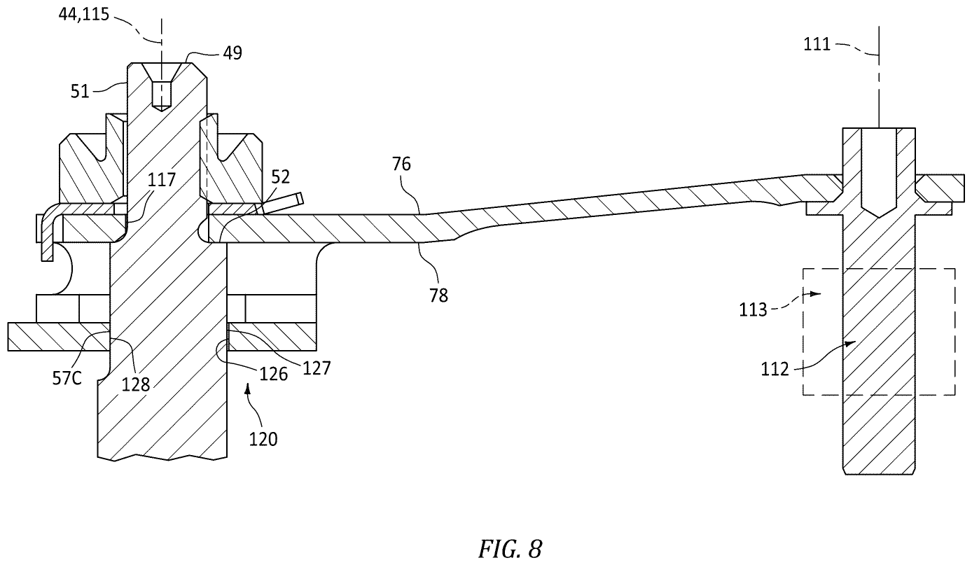

The arm 22 (FIG. 2) extends generally from a first end 70 to a second end 72. In this example, the first end 70 is a driving end and the second end 72 is a driven end. The driving end is coupled to a synchronizing mechanism (e.g., synchronizing ring) so that movement of the synchronizing ring (e.g., typically a rotation about the engine axis coupled with a slight axial translation due to the lever arms) causes rotation of the lever arms and vanes about the respective vane axes 44. Thus, the vane is coupled to the synchronizing ring near the first end 70 and to the vane near the second end 72. The example arm 22 is formed from stamped/bent sheet metal stock (e.g., nickel-based alloy/superalloy such as AMS 5596-UNS N07718 (nominal 52.5Ni—19Cr—3.0Mo—5.1Cb (Nb)—0.90Ti—0.50Al—18Fe)). The arm 22 has a shank 74 extending between the first end and the second end and having a first face 76 and a second face 78 (FIG. 8). These faces 76 and 78 may correspond to faces of the sheet stock or relieved portions thereof. In the example, a portion of the second face 78 is relieved relative to the original sheet stock for lightening. In an example method of manufacture, the stamped sheet stock piece may have an initial cut form of a generally T-like planform/footprint with the first end 70 being the lower end of the leg of the T. The arms of the T form respective tabs projecting laterally from the shank proximate the second end.

FIG. 3 shows the arms/tabs 80 and 82 in their bent configurations with bends 84, 86, respectively extending from a second end portion 88 of the shank to respective distal portions 90, 92 of the arms 80 and 82 (distally of the respective bends 84 and 86). The bends 84, 86 are such that the respective distal portions 90, 92 have faces facing the shank second face 78. These faces may be formed from the same face of original stock as the second face 78. The distal portions overlap the shank (i.e., a line through the shank perpendicular to the faces 76, 78 also intersects the distal portions) and are spaced apart therefrom. Example bends have the effect of forming an essentially 180 ° U-turn. The bend 84 is of tighter curvature than the bend 86 to allow the distal portion 92 to overlap the distal portion 90 (i.e., the distal portion 90 is between the distal portion 92 and the shank). The tabs extend to respective distal ends 100, 102.

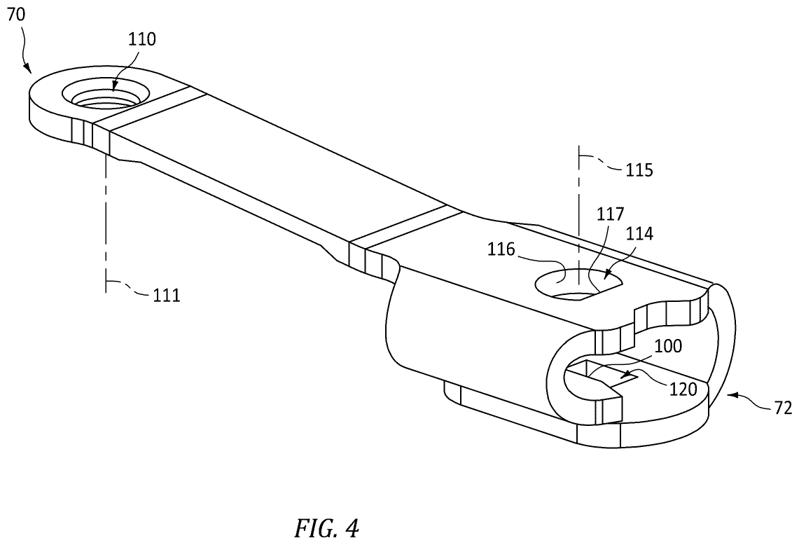

The example vane arm has exactly three through-holes. A first through-hole 110 (FIG. 4) is adjacent the first end 70 for receiving a driving pin 112 (FIGS. 1&2) which, in turn, is mounted to a synchronizing ring 113 (FIG. 8) in common with the pins of the other vanes of the stage and sharing a central longitudinal axis with the engine and the vane stage. The example pin and synchronizing ring are particularly illustrative and, in any implementation as a modification of a baseline, may reflect features of the baseline including the option of a bearing intervening between the arm and pin or similar component. A second through-hole 114 (FIG. 4) is near the second end and receives the OD shaft 42. The example second hole 114 is of partial circular cross-section dimensioned to just accommodate the threaded section 50 and allow the adjacent portion of the surface 78 to rest atop the shoulder surface 52. The hole 110 has an axis 111 shared with the pin 112. The second hole 114 circular portion 116 has an axis 115 coaxial with the axis 44 in a mounted condition. FIG. 4 also shows the hole 114 as having a perimeter portion 117 formed as a flat along a chord of the otherwise circular planform of the hole. This flat/chord forms a keying feature cooperating with a corresponding facet/flat 51 (FIG. 5) that interrupts the threads of the threaded section/region 50. FIG. 8 shows the example flat 117 as extending only partial thickness of the arm diverging from the axis 44 toward the face 78 to ultimately merge with the circular footprint of the hole at the surface 78. An example hole-to hole on-center distance or separation between axes 111 and 115 is about 1.5 inch (38 mm), more broadly 25 mm to 51 mm or 37 mm to 43 mm. An example overall arm length is about 1.7 inch (43 mm), more broadly 30 mm to 80 mm or 35 mm to 60 mm.

A third hole 120 (FIG. 4) is formed in the distal portion 92 of the second tab 82. The example third hole 120, as discussed below, is partially formed as a rounded-corner parallelogram (shown as a right parallelogram/rectangle) having a proximal edge 122 (proximal relative to the lateral junction with the shank), a distal edge 124 and end edges 126 and 128. The distal edge 100 of the first tab is generally parallel to the distal edge 124 of the third hole. In the relaxed condition of the arm, the third hole is partially overlapped or overlaps the first tab distal portion 90.

In the baseline '260 patent, a third hole is generally elongate in the longitudinal direction of the arm and formed as a rounded-corner rectangle with longitudinal ends spaced well from the stem/shaft. The example arm 22 and vane shaft/stem configuration alter the geometry of the longitudinal ends and the relationship to the shaft/stem relative to those of the '260 patent. As is discussed further below, a departure from the rounded-corner rectangle has the proximal longitudinal end 126 (proximal relative to the driving end 170) of the hole 120 having a central concave portion 125 contacting or closely facing the aforementioned intact shaft/stem circular cylindrical portion 127. In the illustrated embodiment, this may be closely facing without contact. Similarly, in distinction to the '260 patent, the end 128 closely faces or contacts the facet 57C. In the illustrated example, there is contact.

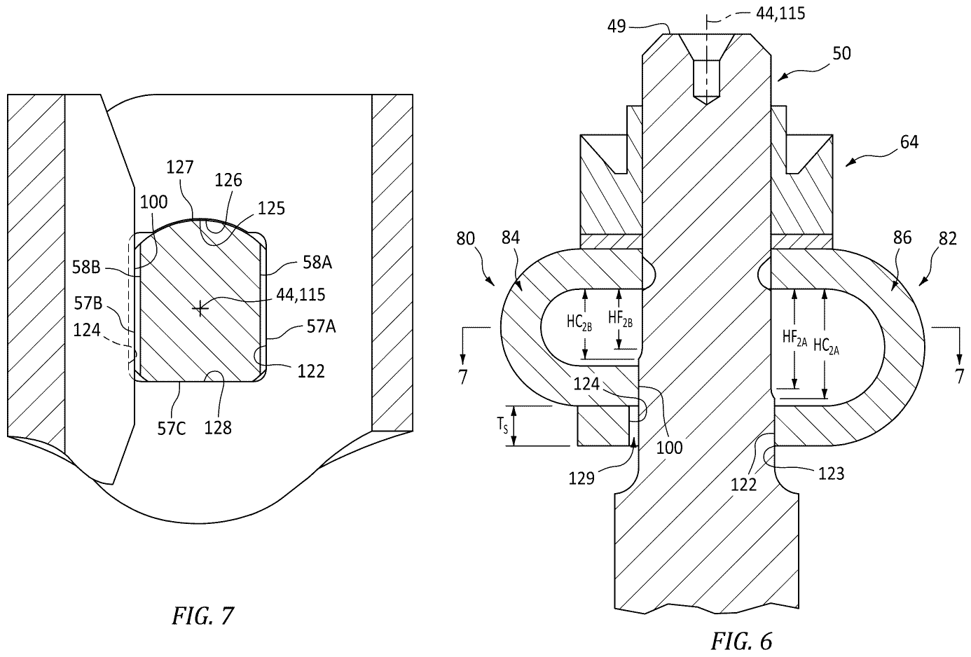

In the properly installed condition, the arm end 100 (FIGS. 6 and 7) is in contact with the facet 57B and the hole 120 proximal edge 122 is in contact with the facet 57A. There may be a slight gap 129 between the hole 120 distal edge 124 and the facet 57B.

A further modification relative to the '260 patent partially shifts the keying function from the head end hole 114 of the leg of the T to the arms/tabs of the T. In the illustrated example, the keying function of the hole 114 is still partially retained by the facet 117 cooperating with the facet 51. Thus, the shift involves additional keying. One aspect of the additional keying is the asymmetry between the hole longitudinal ends/surfaces 126 and 128 and their cooperating shaft/stem surfaces 127, 57C.

Further, additional keying is further achieved by having an asymmetry in the facets on opposite sides of the axis that engage the two arms. The example asymmetry involves differing heights (axial positions) of the upper ends 61A, 61B of the two proximal facets 57A, 57B with steps 59A, 59B thereabove to two additional distal facets 58A, 58B that extend to the shoulder 52 below the threaded portion 54.

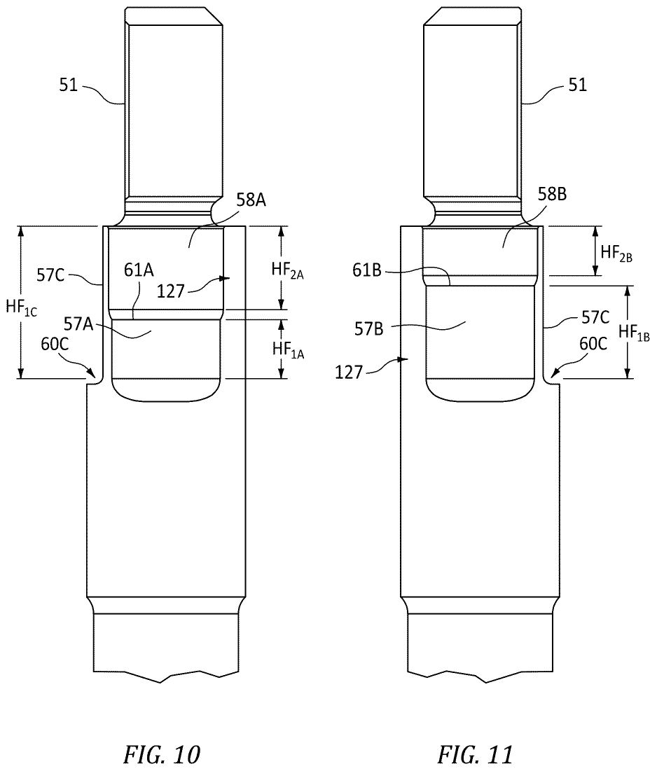

The example shaft/stem lateral face asymmetry involves an axial separation/offset of the upper ends of the facets 57A, 57B by an axial span or offset height H_{O} (FIG. 3). FIGS. 10 and 11, in combination, show the facet 57A as having a height HF_{1A}, and the facet 58A having such a span HF_{2A}. Similarly, the facets 57B and 58B have heights HF_{1B}, HF_{2B}. The transitions or shoulders/steps 59A,59B have heights significantly smaller than either of these. FIG. 6 also shows combined heights HC_{2A} and HC_{2B} for the upper facets and their associated transitions 59A, 59B. Additionally, FIG. 10 shows the facet 57C as having a height or axial span HF_{1C}. In the illustrated embodiment, this extends essentially from the necked portion 54 without the presence of a radially recessed facet such as 58A or 58B. Nevertheless, such a recessed facet and its associated transition may be possible. Generally, the facet 57C at least partially axially overlaps the facet 57A without cooperation with the hole longitudinal distal end 128.

FIG. 9 shows radial separations of the facets from the central axis as SF_{1A}, SF_{2A}, SF_{1B}, SF_{2B}. (for respective combined spacings (or widths between diametrically opposite facets) of SF₁, SF₂) and SF_{1C} for the facet 57C. It also shows the intact circular cylindrical surface 127 radius as R_{S}. In the illustrated example, the separations are the same for both faces 56A, 56B. Thus, the differences or the run of the step between the facets of a given pair Δ_{A} and Δ_{B} are the same. Example Δ_{A} and Δ_{B} are about 1.1 millimeter, more broadly at least 0.50 millimeter or at least 0.75 millimeter with optional upper range limits of 1.5 millimeter or 2.5 millimeter. SF_{1C} is about 80% of R_{S}, more broadly 75% to 85% while being greater than the thread peak radius. Also, the example SF_{1C} is greater than the SF_{1A}, SF_{2A}, SF_{1B}, SF_{2B} values. This helps: prevent attempts at even partially installing in a 90° off-specification orientation; and maintain sufficient shoulder 52 area to bear loads.

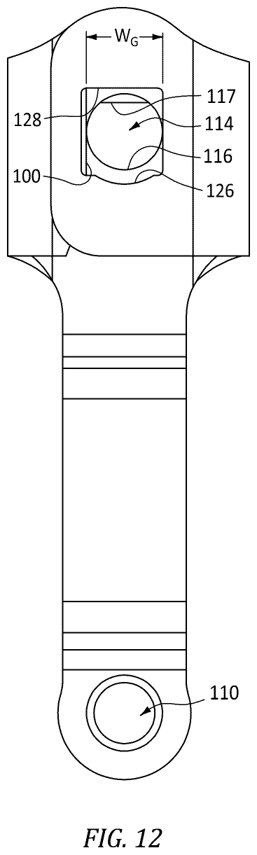

In a normal installation situation, the arms are in their relaxed condition and lateral spacing or gap width W_{G} (FIG. 12) between the faces 100, 122 is greater than the spacing SF₂ between facets 58A, 58B but slightly less than the spacing SF₁ between facets 57A, 57B. Thus, the aperture 120 (width W_{H} greater than SF₁) may slide over the vertical span occupied by the facet 58B so that, during a portion of such movement, the second arm 82 distal portion 92 will be fully within that span and the first arm distal portion 90 will at least be partially within that span. Eventually, one or both of the lower corner/edge 101 (FIG. 3) of the end 100 and the lower corner/edge 123 (FIG. 6) of the hole 120 face 122 will contact the respective transition 59B, 59A and impede further movement absent a driving force to expand the arms laterally outward. This driving force may be imposed by applying and tightening the nut 64 which causes a wedging/camming action due to the slope of the transitions 59B, 59A cooperating with the edges 101, 123. Eventually, such camming action will drive the edges 101, 123 over the lower facet upper edges 61B, 61A and allow seating in the ultimate installed condition of FIG. 6.

Thus, during this process, at the point of initial contact between the edges 101 and 123 and the associated transition 59B, 59A, a given amount of the stem below its upper end 49 (FIG. 3) will protrude beyond the shank of the arm. This amount of protrusion provides a visible indication of proper orientation as discussed further below. Despite the keying features on the stem threaded portion 50 and arm hole 114 provided by the facets 51 and 117, misinstallation is possible. The small size of such features may allow wear or damage to provide enough accommodation for misorientation.

If the arm is attempted to be misinstalled other than essentially 180° misoriented about the axis 44, one or both arms will interfere with the intact circular perimeter of the shoulder 52 90 ° circumferentially between the facets as in the '260 patent. This condition will be clearly evident to the installer because the movement will be stopped with a much reduced height of protrusion of the stem end 49 from the arm shank. In the illustrated example, such protrusion would be almost zero.

At an essentially 180 ° misorientation, in one difference relative to the '260 patent, the foreshortened longitudinal dimension of the hole 120 and asymmetry between its longitudinal ends 126, 128 may cause collision with the shoulder 52. Specifically, the lower edge of the end 128 being a shorter distance from the axes 144, 115 than the arc 125 will cause the underside of the distal portion 92 at the lower edge of the end 128 to collide with the shoulder at the intact circular cylindrical portion 127 to prevent further translation. This relationship provides one keying feature to prevent mis-installation. Even if, due to damage or the like at the ends 126, 128, the arms may pass over the shoulder 52 they then encounter the asymmetry of the axial positions of the transitions/steps 59A, 59B between the facets of a given circumferentially aligned pair. Thus, for example, in such a mis-registered installation attempt, the lower edge 123 of the hole 120 face 122 may contact the step 59B and interfere with further movement. The effect is that the amount of protrusion of the stem from the shank is reduced by the height Ho relative to the corresponding stage of correct installation. This height Ho may, therefore, be chosen to be sufficient to provide a visually recognizable reduction in protrusion. When presented with such visual indication of the mis-installed situation, the installer would know to either reorient by 180 ° or discard one or both of the arm and stem due to whatever the defect is in the keying provided by the cooperation of the hole 114 and threaded portion 50. This is in distinction to a lack of such transition asymmetry potentially allowing two alternative installation orientations 180 ° from each other.

Example H_{O} may be very close to the thickness T_{S} of the arms (FIG. 6) which may also represent the thickness of the original arm sheetstock. Thus, example Ho may be 50% to 150% of T_{S}, more particularly, 75% to 125% or 90% to 110%. Alternatively expressed, H_{O} may be an example about 30% of the spacing SF₁, measured across the axis 44, more broadly 10% to 50% or 20% to 40%. or 25% to 35%. Also, the step runs Δ_{A} and Δ_{B} may be an example 2% of S_{F1}, more broadly 1.0% to 5.0% or 1.5% to 3.5%.

Once installed, contact of the surfaces 58C and 128 (FIG. 7) provides further resistance to relative rotation of the arm and vane about the axes 44,115 to provide enhanced torque transmission. In the illustrated example, there is slight gap between the surfaces 125 and 127. This allows for easy installation. The dimensional/relaxed interference between the surfaces 57C and 128 may be so slight as to not impede installation in view of the ability of the metal to flex slightly. In alternative implementations, there may be a reversal of these with there being initial slight interference between the surfaces 125 and 127 and a gap between the surfaces 57C and 128. Further, the situation may be such that there are nominal slight gaps in both locations. In any event, the net gap or combination of gaps is small such that any relative angular movement about the axes 44, 115 causes contact at the one or both ends where there had not been prior contact to significantly increase resistance to further relative rotation.

In alternative embodiments (not shown), with keying provided by the arms/tabs, the keying function may be removed from the threaded portion 50 of the shaft and the head end hole 114. Thus, the head end hole 114 may be fully circular in footprint and the shaft threads may be uninterrupted.

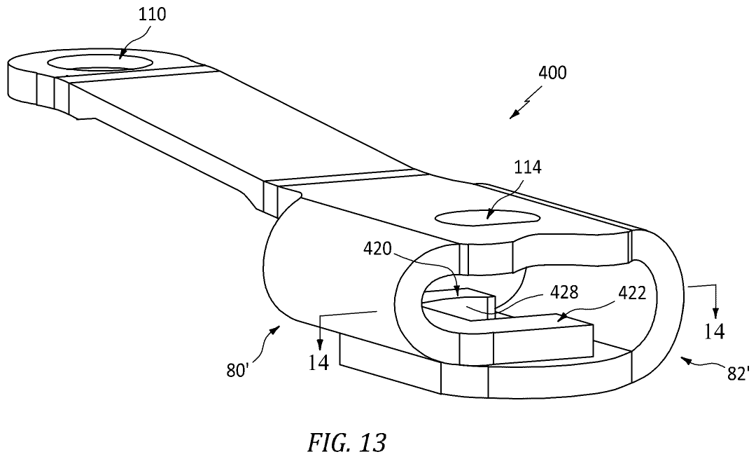

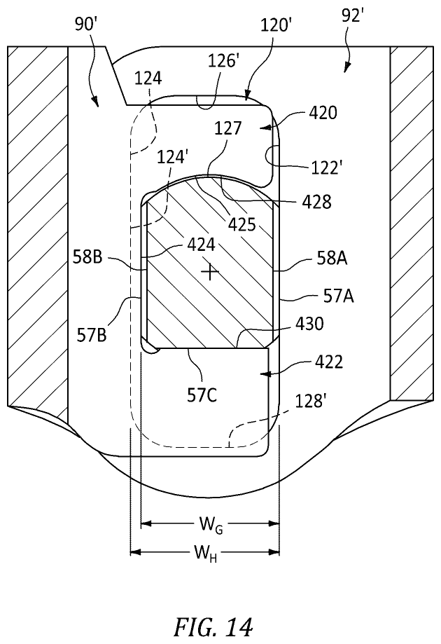

FIG. 13 shows an alternate vane arm 400 which, except as described, may be as described above for the arm 22. The arm 400 may be used with the same vane 24 and FIG. 14 shows details of the arm-to-vane cooperation in a similar fashion to FIG. 7. The difference is that the cooperation with the shaft/stem facet 57C and intact circular cylindrical portion 127 is shifted from the lower arm/tab to the upper arm/tab. The lower tab 412 hole 120′ may be as in the '260 patent being longitudinally elongate between ends 126′ and 128′ which are well spaced apart from the shaft/stem. The hole edges 122′, 124′ may function as do the edges 122 and 124.

The FIG. 14 upper tab 80′ has two lateral projections 420 and 422 which respectively have surfaces 428 and 430 which cooperate with the shaft/stem in a similar fashion to the FIG. 7 surfaces 125/126 and 128. Thus, the upper tab of FIG. 14 forks with the projections 420 and 422 forming the two tines or branches of the fork and thus overlapping the lower tab 92′ hole 120′. The upper tab has an end edge region 424 between the tines similarly positioned to the FIG. 7 end 100 to similarly cooperate with the facet 57B in the fully installed condition.

In a normal installation situation, the arms are in their relaxed condition and lateral spacing or gap width W_{G} (FIG. 14) between the faces 424, 122′ is greater than the spacing SF₂ between facets 58A, 58B but slightly less than the spacing SF₁ between facets 57A, 57B. Thus, the aperture 120′ (width W_{H} greater than SF₁) may slide over the vertical span occupied by the facet 58B so that, during a portion of such movement, the lower tab 82′ distal portion 92′ will be fully within that span and the first arm distal portion 90′ will at least be partially within that span. Eventually, one or both of the lower corner/edge of the end edge region 424 and the lower corner/edge of the hole 120′ face 122′ will contact the respective transition 59B, 59A and impede further movement absent a driving force to expand the arms laterally outward. This driving force may be imposed by applying and tightening the nut 64 which causes a wedging/camming action due to the slope of the transitions 59B, 59A cooperating with those edges. Eventually, such camming action will drive the edges over the lower facet upper edges 61B, 61A and allow seating in the ultimate installed condition of FIG. 14.

Thus, during this process, at the point of initial contact between the edges and the associated transition 59B, 59A, a given amount of the stem below its upper end 49 (FIG. 3) will protrude beyond the shank of the arm. This amount of protrusion provides a visible indication of proper orientation as discussed further below. Despite the keying features on the stem threaded portion 50 and arm hole 114 provided by the facets 51 and 117, misinstallation is possible. The small size of such features may allow wear or damage to provide enough accommodation for misorientation.

If the arm is attempted to be misinstalled other than essentially 180° misoriented about the axis 44, one or both arms will interfere with the intact circular perimeter of the shoulder 52 90° circumferentially between the facets as in the '260 patent. This condition will be clearly evident to the installer because the movement will be stopped with a much reduced height of protrusion of the stem end 49 from the arm shank. In the illustrated example, such protrusion would be almost zero.

At an essentially 180° misorientation, in one difference relative to the first embodiment and similarity to the '260 patent, the hole 120′ does not hinder misinstallation, Instead, that function of the first embodiment is performed by the upper tab. In particular, it is performed by the with the spacing and asymmetry between tines. Such spacing and asymmetry may cause collision of the underside of the tine 422 with the shoulder 52.

Specifically, the lower edge of the tine surface 430 being a shorter distance from the axes 144, 115 than the arc 425 of surface 426 will cause the underside of the distal portion 90′ at the lower edge of the tine 420 surface 428 to collide with the shoulder at the intact circular cylindrical portion 127 to prevent further translation. This relationship provides one keying feature to prevent mis-installation. Even if, due to damage or the like at the surfaces 426, 428, the arms may pass over the shoulder 52 they then encounter the asymmetry of the axial positions of the transitions/steps 59A, 59B between the facets of a given circumferentially aligned pair. Thus, for example, in such a mis-registered installation attempt, the lower edge of the hole 120′ face 122′ may contact the step 59B and interfere with further movement. The effect is that the amount of protrusion of the stem from the shank is reduced by the height H_{O} relative to the corresponding stage of correct installation. This height H_{O} may, therefore, be chosen to be sufficient to provide a visually recognizable reduction in protrusion. When presented with such visual indication of the mis-installed situation, the installer would know to either reorient by 180 ° or discard one or both of the arm and stem due to whatever the defect is in the keying provided by the cooperation of the hole 114 and threaded portion 50. This is in distinction to a lack of such transition asymmetry potentially allowing two alternative installation orientations 180 ° from each other.

Once installed, contact of the surfaces 58C and 128 (FIG. 7) provides further resistance to relative rotation of the arm and vane about the axes 44,115 to provide enhanced torque transmission. In the illustrated example, there is slight gap between the surfaces 125 and 127. This allows for easy installation. The dimensional/relaxed interference between the surfaces 57C and 128 may be so slight as to not impede installation in view of the ability of the metal to flex slightly. In alternative implementations, there may be a reversal of these with there being initial slight interference between the surfaces 125 and 127 and a gap between the surfaces 57C and 430. Further, the situation may be such that there are nominal slight gaps in both locations. In any event, the net gap or combination of gaps is small such that any relative angular movement about the axes 44, 115 causes contact at the one or both ends where there had not been prior contact to significantly increase resistance to further relative rotation.

Component materials and manufacture techniques and assembly techniques may be otherwise conventional. This may involve stamping/machining/press braking from plate stock for arms and casting/machining for vanes.

The use of “first”, “second”, and the like in the following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

One or more embodiments have been described. Nevertheless, it will be understood that various modifications may be made. For example, when applied to an existing baseline vane and arm configuration, details of such baseline may influence details of particular implementations. Accordingly, other embodiments are within the scope of the following claims.

1. A vane assembly comprising a vane having an airfoil and a shaft protruding from an end of the airfoil and a vane arm, the vane arm comprising:
a first end and a second end;
a shank extending between the first end and the second end and having a first face and a second face;
a first hole in the shank proximate the first end;
a second hole in the shank proximate the second end;
a first tab projecting laterally from the shank proximate the second end and having:
a bend; and
a distal portion distally of the bend overlapping and spaced apart from and having a face facing the shank second face; and
a second tab projecting laterally from the shank proximate the second end laterally opposite the first tab and having:
a bend;
a distal portion distally of the bend overlapping and spaced apart from and facing the shank second face and partially overlapping the first tab distal portion; and
a third hole in the second tab and having a proximal edge and a distal edge,
wherein:
the shaft has a first facet abutting the proximal edge of the third hole, a second facet abutting the first tab, and a third facet circumferentially between the first facet and the second facet and abutting at least one of the first tab and the second tab.

2. The vane assembly of claim 1 wherein:
the first tab distal portion is between the second tab distal portion and the shank.

3. The vane assembly of claim 1 wherein:
the vane shaft has a shoulder; and
a nut holds the vane arm to the shaft compressed between the nut and the shoulder.

4. The vane assembly of claim 1 wherein:
tab washer is between the nut and the vane arm and has a tab received in an open channel in the second end.

5. The vane assembly of claim 1 wherein:
the third facet abuts at least one of the first tab and the second tab.

6. The vane assembly of claim 1 wherein:
the third facet abuts at a surface of the third hole.

7. The vane assembly of claim 1 wherein:
the first and second facets have upper ends axially offset from each other.

8. The vane assembly of claim 7 wherein:
the offset is by 10% to 50% of a spacing between the first facet and the second facet.

9. The vane assembly of claim 7 wherein:
the shaft has fourth facet and a fifth facet respectively above the and recessed from the first facet and the second facet.

10. The vane assembly of claim 9 wherein:
the third facet at least partially axially overlaps the first facet, the second facet, the fourth facet and the fifth facet.

11. The vane assembly of claim 1 wherein:
the third facet abuts a projection of the first tab.

12. The vane assembly of claim 11 wherein:
the first tab forks in two with the projection being a tine of the fork.

13. The vane assembly of claim 1 further comprising:
a pin mounted in and protruding from the first hole.

14. A vane stage comprising a plurality of vane assemblies of claim 1 and further comprising:
a synchronizing ring coupled to the vane arms and having an axis; and
for each vane assembly one or more bearings mounting the vane for rotation about an axis of the vane wherein, rotation of the synchronizing ring about its axis rotates the vanes about their respective axes.

15. The vane assembly of claim 1 wherein:
the first tab forks with a first tine of the fork abutting the third facet and overlapping the third hole.

16. The vane assembly of claim 15 wherein:
a second a tine of the fork overlaps the third hole.

17. The vane assembly of claim 16 wherein:
the second tine has a concavity facing the first tine.

18. The vane assembly of claim 1 wherein:
the third hole has a flat between the third hole distal edge and third hole proximal edge; and
the third hole has a concavity between the third hole distal edge and the third hole proximal edge and facing the third hole flat.

19. The vane assembly of claim 18 wherein:
the first, second, and third holes are in a single metallic piece.

20. The vane assembly of claim 18 wherein:
the first, second, and third holes are the only holes in the vane arm.
